(19) United States
(12) Patent Application Publication
(10) Pub. No.: US 2014/0306457 A1
(43) Pub. Date: Oct. 16, 2014

(54) CURTAIN-SUSPENSION-TYPE POWER-GENERATING APPARATUS

(71) Applicant: Yong-Tak Kim, Gyeongsangnam-do (KR)

(72) Inventor: Yong-Tak Kim, Gyeongsangnam-do (KR)

(21) Appl. No.: 14/003,823

(22) PCT Filed: Mar. 21, 2012
(86) PCT No.: PCT/KR12/01996

§ 371 Date: Oct. 3, 2013

(30) Foreign Application Priority Data
Mar. 22, 2011 (KR) 10-2011-0025097

(51) Int. Cl. F03D 3/00; F03D 9/00

(52) U.S. Cl. CPC F03D 3/005; F03D 9/002
USPC 290/55

(57) ABSTRACT

Provided is a curtain-suspension-type power-generating apparatus in which generator bodies, i.e. turbines using the force of the wind, are vertically and densely suspended from upper and lower wire ropes connected in parallel, such that the generator bodies rotate along the upper and lower wire ropes. The curtain-suspension-type power-generating apparatus comprises: a plurality of curved turbine blades which rotate by means of the wind blowing from the outside; a generator coupled in a straight line to the center of the turbine blades; an upper wire rope and a lower wire rope connected between the upper ends or lower ends of steel towers such that the upper wire rope and the lower wire rope are arranged in parallel; and a plurality of generator bodies densely installed at the upper and lower wire ropes arranged in parallel. The number of the wire ropes having the plurality of generator bodies installed thereon may be one, two, three, or more connected together so as to form a radial shape. The thus-configured curtain-suspension-type power-generating apparatus may easily generate electrical energy in any place in which there is wind, and may mass-produce electrical energy.

### BACKGROUND OF THE INVENTION

The present invention relates to a curtain-suspension-type power generating apparatus in which a plurality of generator bodies, i.e. wind turbines, are vertically and densely suspended from upper and lower wire ropes connected and fixed in parallel, such that the generator bodies rotate along the upper and lower wire ropes.

The need of development of alternative energies and utilization of renewable energies in the present age that energy problems occur due to a crisis of global environment is growing more.

Bioenergy, solar power, hydrogen, wind power and others are used as new and renewable energies, but generation of power using such new and renewable energies have many limitations in various aspects such as facilities or scale and are mostly not efficient.

In case of wind power generation, because wind in high places must be used, pillars are erected high and blades of turbines are attached to the pillars. However, because the blades are manufactured narrowly and robustly due to a high resistance of wind and are manufactured in such a manner that just a small percentage of the cross sectional area of the win is applied to the blades, it is low in efficiency. Moreover, the pillars need big and substantial facilities in order to endure great load and resistance. That is, the wind power generation needs high expenditures and restricted facilities.

The existing wind power generation has the task of enlarging the area to catch the wind, and has several problems in that the wind power generation is restrictedly applied to other existing new and renewable energy facilities, is complicated in structure, and needs lots of manufacturing expenses.

### SUMMARY OF THE INVENTION

Accordingly, the present invention has been made in an effort to solve the above-mentioned problems occurring in the prior arts, and it is an object of the present invention to provide a curtain-suspension-type power generating apparatus, which includes steel towers installed two or more places in order to use wind energy, upper and lower wire ropes disposed in parallel and firmly connected between the steel towers, several tens or several hundreds of generator bodies, which are wind turbines, vertically suspended on the upper and lower wire ropes opposed to each other, such that it maximize a cross section to catch kinetic energy of the wind blowing in many directions, thereby converting most of wind energy into electric energy without regard to the direction of the wind and generating a great deal of power.

To achieve the above objects, the present invention provides a curtain-suspension-type power generating apparatus comprising: a plurality of curved turbine blades which rotates by means of the wind blowing from the outside; a generator fixed and joined in a straight line to the integrated turbine blades via a shaft and a bearing; upper and lower wires disposed in parallel whose upper ends are connected to the upper ends of the pillars and whose lower ends are connected to the lower ends of the pillars, the upper and lower wires being connected to the steel towers horizontally long; generator bodies, which are several tens or several hundreds of wind turbines, densely suspended on the upper and lower wires arranged in parallel so as to generate power. The rotating integrated turbine blades are connected to the lower shaft via bearings and the lower shaft is fixed and joined to the lower wire by bolts, and on the other side, the integrated turbine blades are fixed and connected to the shaft and a magnet is joined to an end of the shaft in such a way as to interlock with a coil fixed to the generator frame. The lower side of the generator frame which is the direction of the integrated turbine blades is joined to the shaft via the bearing and the upper side is fixed and joined to the upper wire via bolts, so that the generator frame is vertically suspended on the upper wire and fixed to the upper and lower wire ropes which are in parallel.

In this instance, because the turbine blades rotates so as to rotate the magnet joined to the end of the shaft, electricity is generated due to changes of magnetic flux by the coil mounted inside the generator frame, and the electricity is stabilized by the connected converter and sent to current lines, and electric currents flowing from the converters are collected and sent to the power lines. Here, several tens or hundreds of the generator bodies are suspended on the upper and lower wire ropes to catch the wind like a folding screen.

Moreover, packings are disposed outside the bearings and the bolt fixing parts where the components of the generator are assembled to thereby prevent leakage of water such as rainwater or foreign matters.

Furthermore, a lightning rod and a lightning line for preventing lightning are mounted, and support insulators for spacing the wires from the lightning line at a safe interval are also mounted.

Additionally, the pillars and steel towers for supporting the upper and lower wires, and the lightning rod and lightning line for preventing lightning and for catching more wind on the air are installed, and in this instance, fixing wires for connecting the upper part of the pillars and the ends of the steel towers with concrete anchors which are buried under the ground are further mounted.

According to the present invention, when wind blows on the air, kinetic energy of the wind rotates the integrated turbine blades and the rotary force of the turbine rotates the magnet connected thereto, so that electric currents are generated in the coils inside the generator frame fixed to the upper wire so as to generate electricity. The generated electricity is stabilized through the converters and sent to the power lines. Here, the generator bodies vertically suspended on the upper and lower wires and fixed to the wires in a straight line become one generator body. That is, because several tens or hundreds of the generator bodies are vertically installed on the upper and lower wires disposed in parallel, the generator bodies spread like a folding screen, and hence, generate a great deal of power between the upper and lower wires.

Moreover, because the turbine blades are rotated even by weak wind at a speed of 1 m/s to 2 m/s, the power generating apparatus can generate power, and can also generate power even by typhoons because they are supported by the upper and lower wires disposed in parallel and having strong intensity. Additionally, the power generating apparatus can effectively generate power even though wind blows in any directions.

Furthermore, because the generator bodies are vertically fixed to the strong upper and lower wires which are made by twisting several steel ropes, they are not related with torsional moment and can maximize an area to catch the wind. Because the generator bodies are vertically fixed and generate power in one direction, the power generating apparatus is safe since it prevents inflow of rainwater or foreign matters, and is convenient in repairing after disassembling the generator bodies. That is, the power generating apparatus can be easily repaired and replaced because the generators or the parts of the generators can be replaced just by releasing and tightening some bolts. Additionally, the bearings which are frequently replaced due to their short lifespan can be easily replaced.

Because the parallel upper and lower wires can cross valleys or can be installed long over deserts, mountains or seas according to their thicknesses, the upper and lower wires can be installed long to withstand even typhoons. Therefore, because the upper and lower wires are installed very long, several tens or hundreds of generator bodies can be installed to the upper and lower wires so as to maximize the area to catch the wind. Of course, it is possible within a range of sufficient tension according to the upper and lower wires, but it is possible because the upper and lower wires are varied in thickness.

As described above, in order to effectively enlarge the area to catch the wind, the upper and lower wires are arranged radially or in a mesh form so as to effectively use the wind.

Moreover, in order to hide the wind power generators, the generator bodies are put in the screen. Then, the screen passes the wind and hides the rotating generator bodies so as to function as windbreaks on the seashore or to provide a beautiful appearance of the power generating apparatus, so that the power generating apparatus can be used as garniture or installed in any place like a building. It means that the power generating apparatus can generate power in any place where there is wind without people's feeling of refusal.

Therefore, the power generating apparatus according to the present invention can be replaced with the existing wind turbines which are restricted and have a very small area to catch the wind but are big and expensive. That is, in case of the existing wind turbines, a ratio to generate power by catching the blowing wind is just a small percentage of the blowing wind, namely, the area of the turbine blades is a very small percentage of the area of the diameter, and hence, it is very low in efficiency in comparison with the large and big facility. However, the curtain-suspension-type power generating apparatus using the upper and lower wires disposed in parallel can generate power up to 50% in contrast with the area because the turbine blades can be enlarged in various ways and the upper and lower wires have high tension, and hence, the power generating apparatus according to the present invention can generate lots of power in a wide area in contrast with the facility. Namely, the power generating apparatus according to the present invention can generate power in the wide area as much as it nearly stops the blowing wind.

### BRIEF DESCRIPTION OF THE DRAWINGS

FIG. 1 is an assembly diagram of a curtain-suspension-type power generating apparatus according to the present invention.

FIG. 2 is a perspective view of a two-pillar curtain-suspension-type power generating apparatus according to the present invention.

FIG. 3 is a perspective view of a three-pillar curtain-suspension-type power generating apparatus according to the present invention.

FIG. 4 is a perspective view of a multiple-pillar curtain-suspension-type power generating apparatus according to the present invention.

FIG. 5a is a half-sectional view and a partially sectional view of a generator body according to the present invention (indicated names of parts of the generator body and a turbine blade).

FIG. 5b is a half-sectional view and a partially sectional view of a generator body according to the present invention (indicated names of parts of a shaft and a lower shaft).

FIG. 5c is a half-sectional view and a partially sectional view of a generator body according to the present invention (indicated names of parts of a wire part).

FIG. 5d is a detailed view of the upper part of the generator body according to the present invention.

FIG. 5e is a detailed view of a turbine blade part of the generator body according to the present invention.

FIG. 5f is a detailed view of a lower shaft of the generator body according to the present invention.

FIG. 6 is a detailed view of a support part according to the present invention.

FIG. 7 is a flow chart of wind kinetic energy of the turbine blade part according to the present invention.

FIG. 8 is a sectional view of a concrete anchor according to the present invention.

FIG. 9 is a detailed view of a screen according to the present invention.

FIG. 10 is a wiring diagram of the wire part according to the present invention.

### DETAILED DESCRIPTION OF THE INVENTION

A curtain-suspension-type power generating apparatus according to the present invention includes: a plurality of curved turbine blades which rotate by means of the wind blowing from the outside; a generator coupled in a straight line to the center of the turbine blades; upper and lower wires connected between the upper ends or between the lower ends of the steel towers in two lines such that the upper and lower wires are arranged in parallel; and a plurality of generator bodies densely installed at the upper and lower wires arranged in parallel. The number of the wire ropes to which the generators are mounted may be one, two, three or more or the wire ropes may be connected radially. One side of the turbine blade is joined to the upper and lower wires by a bearing and the other side is fixed and connected to a shaft, and a magnet is joined to an end of the shaft in such a way as to interlock with a coil fixed to the generator frame. The generator frame is bearing-coupled in the direction of the turbine blades and vertically joined to the lower wire by a lower shaft, and on the other side, the generator frame is vertically fixed to the upper wire by bolts.

In this instance, because the turbine blades rotates so as to rotate the magnet joined to the end of the shaft, electricity is generated by the coil mounted inside the generator frame, and the electricity is stabilized by the connected converter and sent to current lines, and electric currents flowing from the converters are collected and sent to the power lines.

Moreover, packings are disposed outside the bearings and the bolt fixing parts where the components of the generator are assembled to thereby prevent leakage of water such as rainwater or foreign matters.

Furthermore, a lightning rod and a lightning line for preventing lightning are mounted, and support insulators for spacing the wires from the lightning line at a safe interval are also mounted.

Additionally, the pillars and steel towers for supporting the upper and lower wires, and the lightning rod and lightning line for preventing lightning and for catching more wind on the air are installed, and in this instance, fixing wires for connecting the upper part of the pillars and the ends of the steel towers with concrete anchors which are buried under the ground are further mounted.

Because a plurality of the generator bodies are vertically and densely installed on the upper and lower wires disposed in parallel, the power generating apparatus according to the present invention can show the curtain-suspension-type power generation like a folding screen, and because the integrated turbine blades can be installed long and widely, the power generating apparatus can maximize the area to catch wind so as to generate lots of power.

Because a screen hides the generator bodies, makes the appearance beautiful and passes just the wind, the power generating apparatus can generate power in a state where the rotating generator bodies are not viewed in any directions.

Therefore, the power generating apparatus can generate electricity in any place where there is wind without people's feeling of refusal and can produce a great deal of electric energy.

Hereinafter, reference will be now made in detail to a magnet vibration device using external pressure according to the present invention with reference to the attached drawings. However, the present invention is not restricted to the embodiments of the present invention but can be embodied in other various forms.

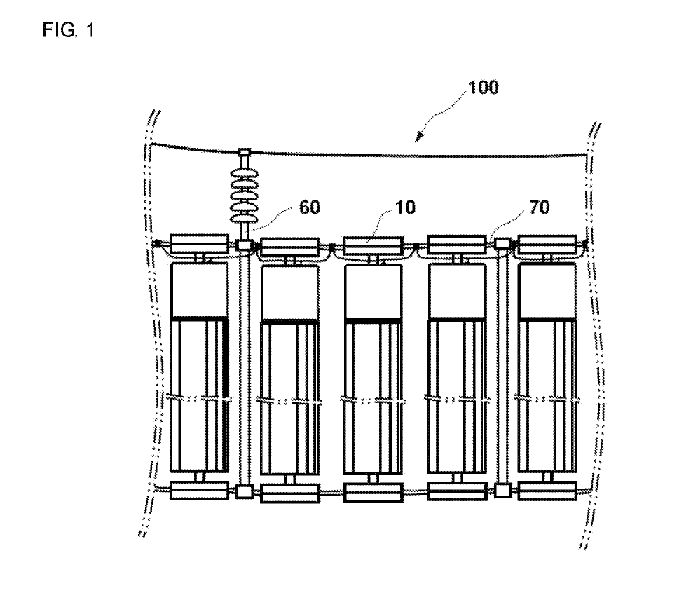

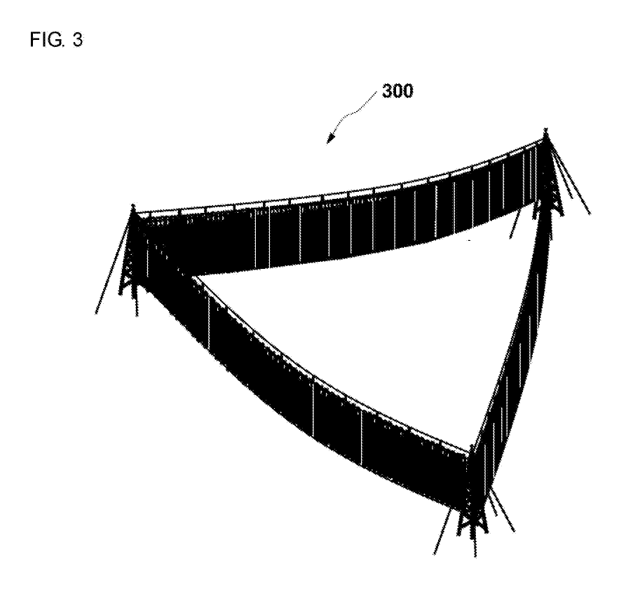

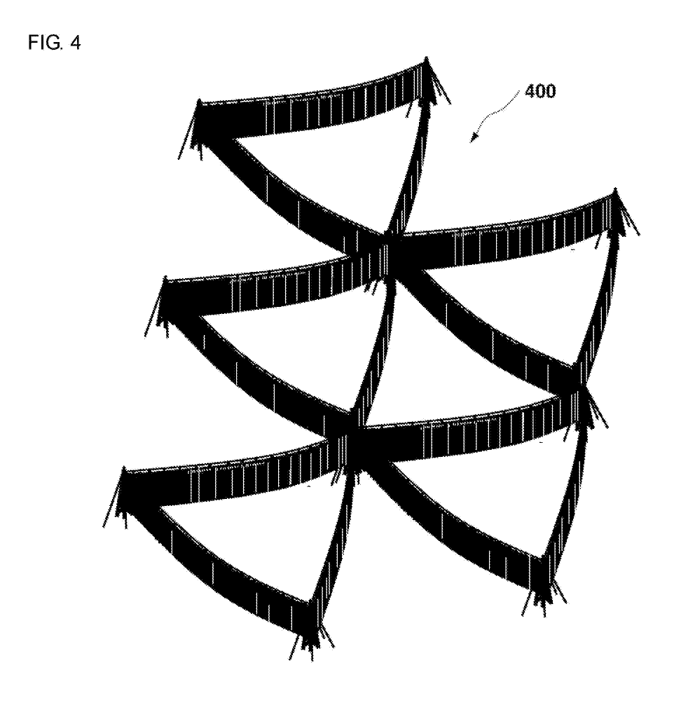

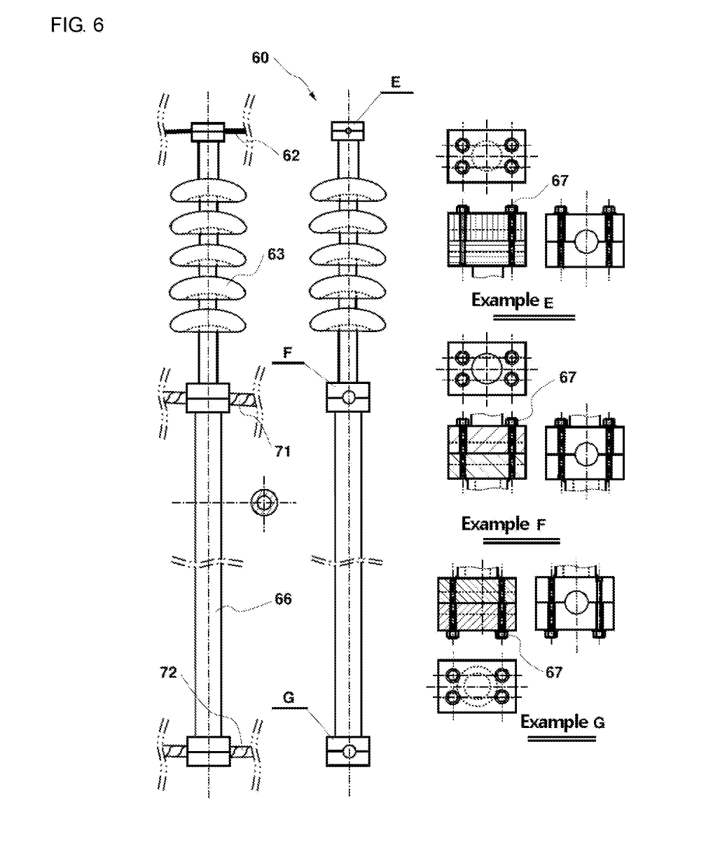

Referring to FIGS. 1 to 10, the curtain-suspension-type power generating apparatus 100 according to the present invention will be described.

Referring to FIGS. 1 to 4 and 9, the curtain-suspension-type power generating apparatus 100 according to the present invention may be one of a two-pillar curtain-suspension-type power generating apparatus 200, a three-pillar curtain-suspension-type power generating apparatus 300, and a multiple-pillar curtain-suspension-type power generating apparatus 400, and includes generator bodies 10, a support part 60, a wire 70, a steel tower 80, a screen 90, and a fixed wire 81.

The steel tower 80 is erected at height that the steel tower 80 can sufficiently support upper and lower wires 71 and 72, endure weight of the generator bodies 10 suspended on the upper and lower wires 71 and 72 in parallel, sufficiently bear natural disasters such as typhoons and earthquake, and sufficiently catch the wind up in the air. The parallel upper and lower wires 71 and 72 can sufficiently endure tension when a worker buries a concrete anchor 82 under the ground 83 by sufficiently pulling the upper and lower wires 71 and 72 with the fixed wire 81. The upper and lower wires 71 and 72 made by twisting a plurality of steel ropes are made thick so as to have a high intensity, and the concrete anchor 82 is buried under the ground 83 deep so as to have a strong tension.

Here, the steel tower 80 can stand on any places, such as mountains, hills, seas, deserts, and buildings, and can always generate power if the wind blows at a speed of 1 m/s to 2 m/s and more. That is, the two-pillar curtain-suspension-type power generating apparatus 200, the three-pillar curtain-suspension-type power generating apparatus 300, and the multiple-pillar curtain-suspension-type power generating apparatus 400 can always generate power if the wind blows at a speed of 1 m/s to 2 m/s and more.

The power generating apparatus can show excellent power generation because it can endure earthquake and typhoons by the strong tension of the upper and lower wires 71 and 72. The reason is that the power generating apparatus naturally generates power when the wind speed is more than 1 m/s to 2 m/s and the turbine blade part 30 formed integrally is not rotated rapidly even though the speed of typhoon is more than 10 m/s to 30 m/s.

First, the structure of the power generating apparatus according to the present invention will be described. The upper ends of the upper and lower wires 71 and 72 which are arranged in parallel and are made by twisting a bundle of steel ropes are connected to the upper ends of the high pillars supported by the steel tower 80 and the lower ends of the upper and lower wires 71 and 72 are connected to the lower ends of the high pillars, and as shown in FIG. 1, the generator bodies 10 are vertically suspended on the upper and lower wires 71 and 72 in such a manner that generator frames 12 face upwards. Moreover, the generator bodies 10 are spaced apart from each other such that they do not bump against each other by wind. Then, an area to catch the win is maximized, so that most of wind energy can be used. That is, a curtain-type power generation for getting the win to the maximum can be achieved.

In order to assemble, disassemble and repair the power generating apparatus, heavy equipment such as cranes is used. Because it is convenient to disassemble or integrally assemble the generator bodies 10 at the time of repairing, the generator bodies 10 can be replaced or repaired in one set. Because the parallel upper and lower wires 71 and 72 can cross valleys or can be installed long over deserts, mountains or seas according to their thicknesses, the upper and lower wires 71 and 72 can be installed long to withstand even typhoons. The parallel upper and lower wires 71 and 72 can withstand even great tension because they are very thick.

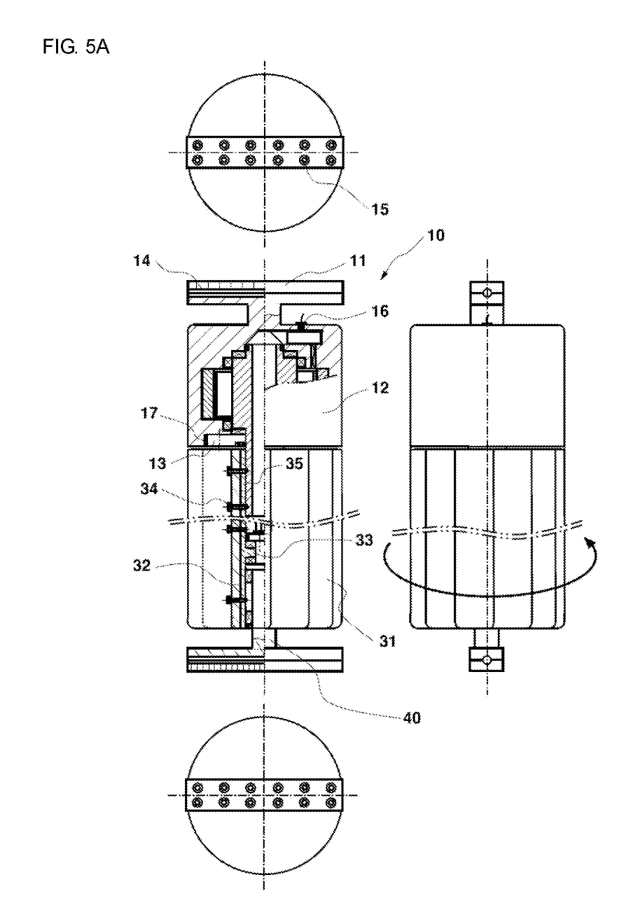

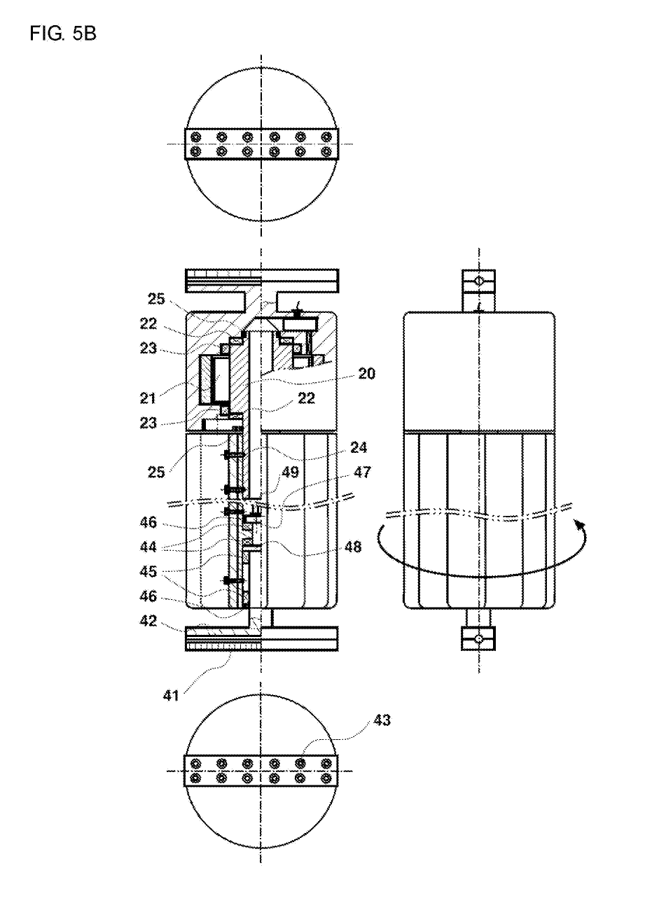

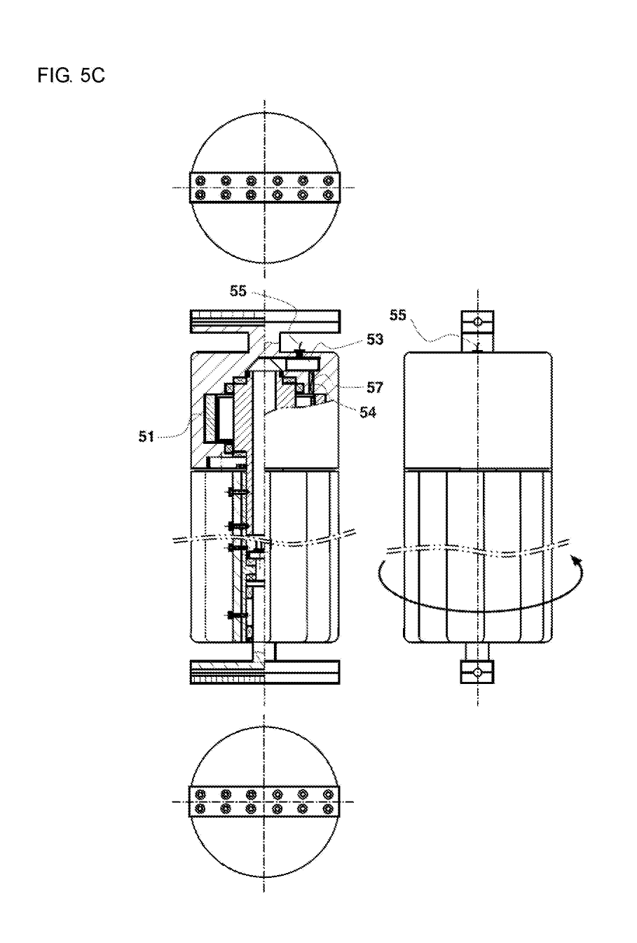

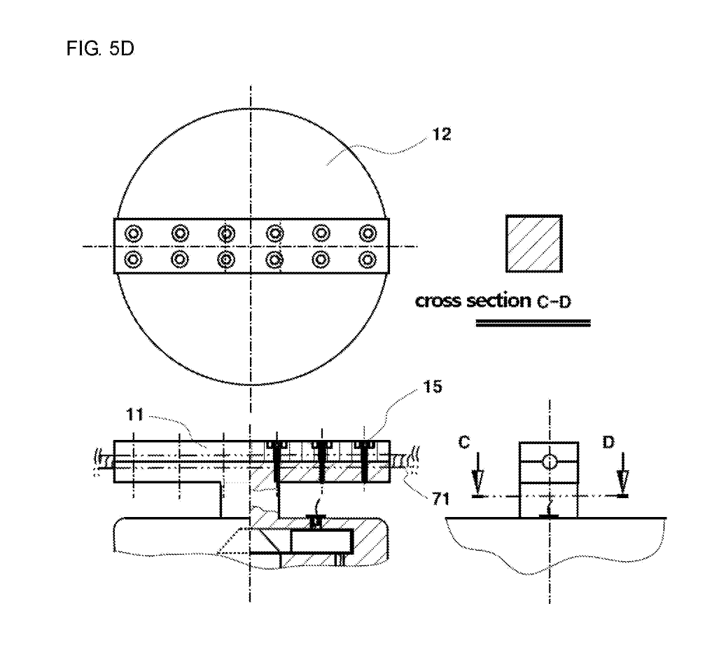

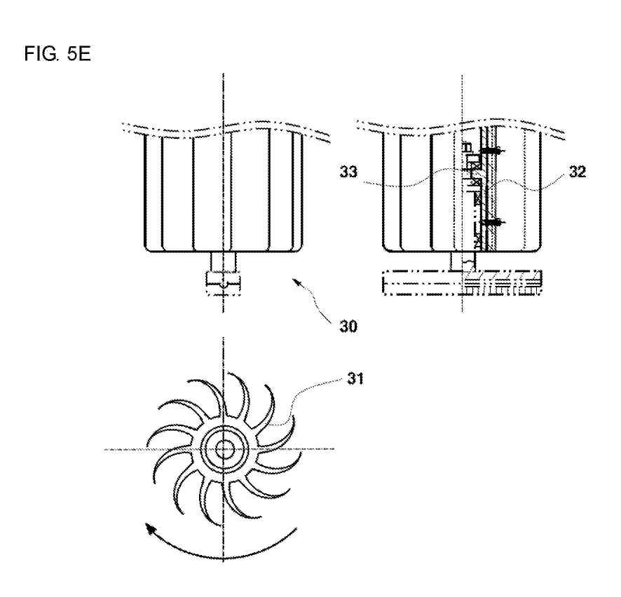

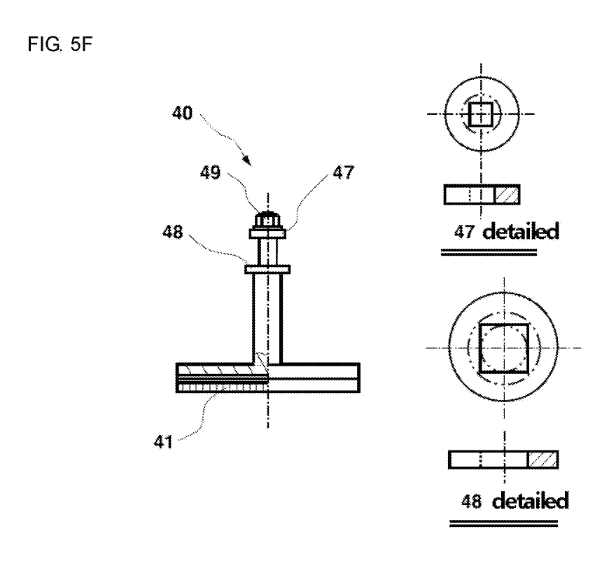

As shown in FIG. 5a, the generator bodies 10 are safe against rainwater because the generator frames 12 face upwards so that rainwater does not get into the generator bodies 10. Furthermore, the generator bodies 10 are not influenced by torque due to the rotation of the turbine blade part 30 because they are fixed long to the strong and parallel upper and lower wires 71 and 72 by means of long wire fixing covers 11. In other words, the torque is offset by the upper and lower wires 71 and 72 so as not to be influenced by distortion due to rotary power. Several tens or several hundreds of the generator bodies 10 can be installed on the long upper and lower wires 71 and 72 so as to generate great power. Electricity of converter lines 55 drawn out from the generator bodies 10 are collected to a power line 52, and the power line 52 is installed along the upper wire 71. As shown in FIG. 10, line fasteners 56 fasten the power line 52 in between so that the power line 52 is not shaken by wind.

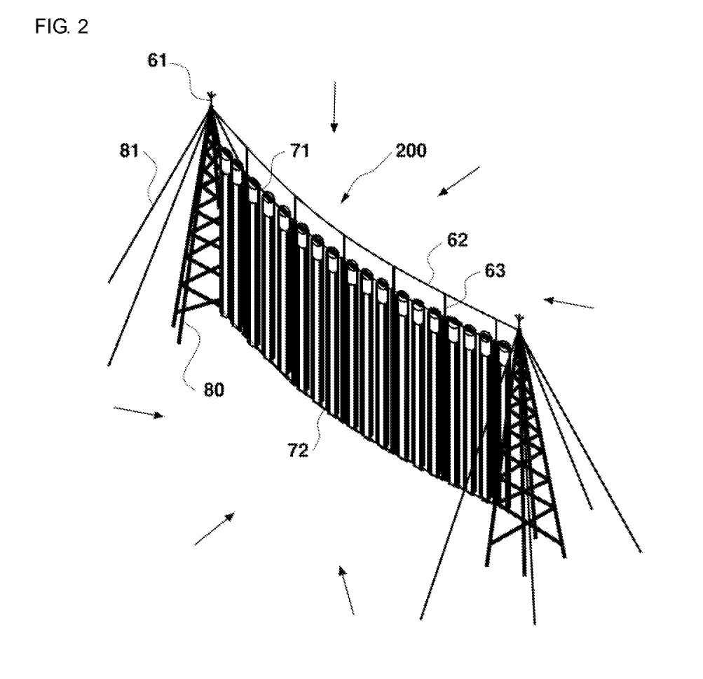

Several tens or several hundreds of generator bodies 10 are installed on long ropes of the upper and lower wires 71 and 72 according to the intensity of the upper and lower wires 71 and 72, and the upper and lower wires 71 and 72 are connected at two or more points of the pillars supported by the steel tower 80 so as to maximize the area to catch the wind, so that the power generating apparatus can generate power very effectively. Particularly, when the upper and lower wires 71 and 72 are made by twisting a plurality of ropes so as to enlarge the area to catch the wind, the upper and lower wires 71 and 72 can maximize the area to catch the blowing wind because they become a radial contexture or a mesh contexture so as to show the best power generation. In this case, it is possible to generate power as much as to nearly stop the wind corresponding to the area to catch the blowing wind. Therefore, the upper and lower wires 71 and 72 can show the best power generation for wind power generation. As shown in FIG. 2, even though the direction of the blowing wind is varied in several directions, the power generating apparatus according to the present invention has a structure to generate power.

Furthermore, a lightning rod 61 for preventing lightning is installed on the steel tower 80. As shown in FIG. 2, a lightning line 62 for preventing lightning is installed above the upper wire 71 arranged horizontally while keeping an interval between the upper wire 71 and the lightning line 62 by support insulators 63.

The steel tower 80 is firmly supported by a plurality of fixing wires 81 to the opposite side in order to provide a strong tension to the wires 71 and 72, and then big and strong concrete anchors 82 are buried deep under the ground 83 so as to provide a great tensile force.

Now, referring to FIGS. 5a, 5b, 5c, 5d, 5e and 5f, the generator bodies 10 will be described.

As shown in FIG. 5a, each of the generator bodies 10 includes the turbine blade part 30 and the generator frame 12, and the turbine blade part 30 and the generator frame 12 are joined together via a shaft 20. The shaft 20 is empty and is fixed and joined to the turbine blade part 30 by turbine blade fixing bolts 34, and a magnet 21 is fixed and joined to the other side of the shaft 20. The outside of the turbine blade part 30 is joined with a thrust bearing 44 and a roller bearing 45, joined to a lower shaft 40, and is sealed by an oil seal 46 as shown in FIG. 5b. The lower shaft 40 joined with the thrust bearing 44 and the roller bearing 45 outside the turbine blade part 30 fixes a wire fixing cover 41 to the lower wire 72 into a wire fixing hole 42 via bolts 43 in the longitudinal direction of the lower wire 72 in order to prevent torque to the lower wire 72, and the generator bodies 10 are vertically fixed to the lower wire 72. Then, the lower shaft 40 is firmly fixed to the lower wire 72. The generator frame 12 of the right side is joined to the shaft 20, to which the magnet 21 is fixed and joined, through the thrust bearing 22 and the roller bearing 23. As shown in FIG. 5a, the converter line 55 is drawn out from the generator frame 12 through a packing 16. The oil seal 25 is interposed between a bracket 13 joined with the generator frame 12 and the shaft so as to seal therebetween. Additionally, a converter 53 which is connected by a coil current line 54 for converting electric current flowing from a generator coil 51 is installed inside the generator frame 12. In addition, electricity generated from the generator coil 51 by the rotation of the magnet 21 due to magnetic flux changes flows to the coil current line 54 and goes into the converter 53. Electric current flowing from the converter 53 is collected into the power line 52 through the converter line 55. The generator frame 12 of the upper wire 71 fixes a wire fixing cover 11 to the upper wire 71 into a wire fixing hole 14 via bolts 15 in the longitudinal direction of the upper wire 71 in order to prevent torque, and the generator bodies 10 are vertically fixed to the upper wire 71. Then, the generator frame 12 is firmly fixed to the upper wire 71. The thrust bearing 22 inside the generator frame 12 is joined to the a bracket 13 via bolts and supports the shaft 20, and then, the oil seal 25 is arranged between the bracket 13 and the shaft 20 to seal therebetween. A packing 17 is disposed between the bracket 13 and the generator frame 12.

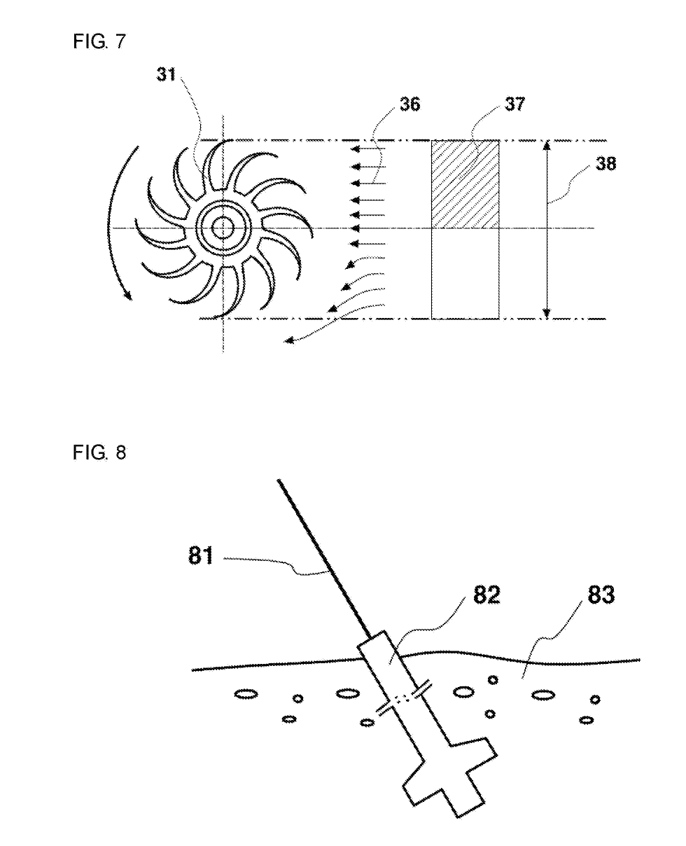

An integrated turbine blade 31 may be made of relatively strong and lightweight metal material or carbon composite, which is endurable against wind or sunlight. The turbine blade may be made in an integrated type or a split type divided in the longitudinal direction. As shown in FIGS. 5e and 7, blades are bent in one direction so as to have a curved surface and the number of the blades is set properly in such a way as to get the wind energy to the maximum. The integrated turbine blades 31 may have a large diameter so as to enlarge the area to catch the wind. Moreover, the integrated turbine blades 31 may be enlarged in the longitudinal direction so as to endure flexural strength to maximize the area to catch the wind.

Now, the operation principle of the integrated turbine blades 31 will be described. First, the integrated turbine blades 31 will be described in detail because they are the most important parts to catch the wind energy. The manufacturing method is the same as the above. As shown in FIG. 7, a width 38 of the diameter to which wind acts is the area that the wind is generally applied to the integrated turbine blades 31, but only an effective area 37 of the wind kinetic energy corresponding to half of the area rotates the integrated turbine blades 31 so as to convert into the kinetic energy of the shaft 20, and hence, just less than 50% of the area of the integrated turbine blades 31 generates power. However, the power generating apparatus according to the present invention provides excellent power generation because the upper and lower wires 71 and 72 are very long, generates power by receiving all the wind like a curtain, and can convert most of the rest of the wind energy into the kinetic energy because a plurality of the wire ropes are arranged in the mesh structure when the rest of the wind energy goes back. Particularly, the integrated turbine blades 31 with the mesh structure can generate power enough to nearly stop the wind. It is like low mountains and trees nearly calming wind. As shown in FIG. 5e, the integrated turbine blades 31 are made integratedly by putting a turbine blade shaft 32 therein in order to enhance intensity and make the turbine blades 31 long. The integrated turbine blades 31 made of the strong and lightweight metal material or the carbon composite are made strongly and integratedly so as not to be separated from the turbine blade shaft 32, and each of the turbine blades 31 has a bearing jaw 33 to support the thrust bearing 44. When the shaft 20 and the integrated turbine blades 31 are assembled, an adhesive 35 is put between the shaft 20 and the turbine blades 31 so as to seal the inside, and the turbine blades 31 are fixed to the shaft 20 by the turbine blade fixing bolts 34. In this instance, the shaft 20 has bolt fixing holes 24, such that the generator bodies 10 are not separated from the shaft 20 by tensile force or compression force. The oil seal 46 is disposed for providing sealing between the shaft 20 and the lower shaft 40.

As shown in FIGS. 5b and 5f, the lower shaft 40 endures tensile force and compression force through a thrust bearing upper fixing ring 47 and a thrust bearing lower fixing ring 48.

Roller bearings 23 and 45 are respectively disposed on the upper rotating body so as to support the rotating body.

Therefore, because the generator frame 12 and the lower shaft 40 are firmly fixed to the upper and lower wires 71 and 72, the power generating apparatus accepts just the rotation of the integrated turbine blades 31 but does not accept movement of other components even in strong external physical environment.

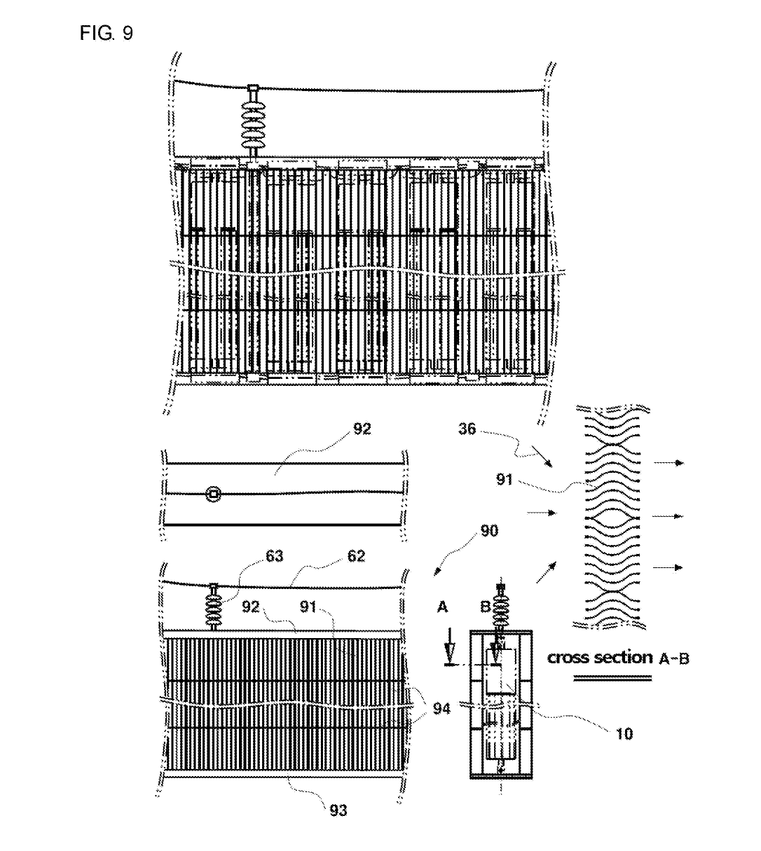

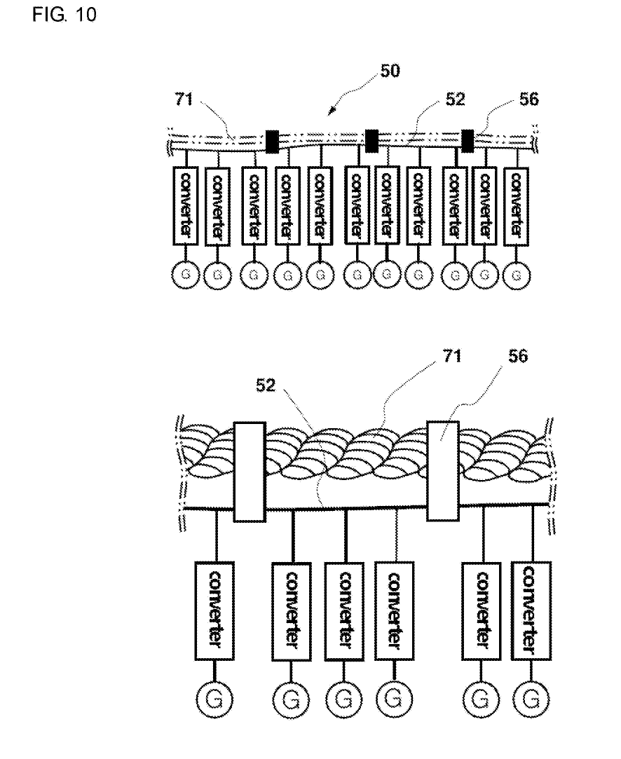

The screen 90 is a cover to hide the rotating generator bodies 10. As shown in FIG. 9, the screen 90 includes a curved iron plate 91, an upper cover 92, a lower cover 93, and a support plate 94, and is used to hide the rotating generator bodies 10 and make the appearance beautiful. The screen 90 passes just the wind to generate power. The generator bodies 10 disposed inside the screen 90 are not viewed in any direction due to the curved iron plate 91. The curved iron plate 91 passes wind well because it is curved. As shown in FIG. 9, the curved iron plate 91 can make flow in wind so as to generate power even though the direction of the wind flow 36 is varied. The support plate 94 keeps strength of the curved iron plate 91. The screen 90 is fixed by bolts 15 and 43 when it is assembled. Therefore, because the screen 90 make the power generating apparatus beautiful, it can be installed at any place where wind blows in order to generate power. For instance, the power generating apparatus having the screen can be installed in places where many people are gathered or on rooftops of buildings, and may be used in place of windbreaks of the seashore.

FIG. 10 shows a circuit of an electric wire part.

When the integrated turbine blades 31 are rotated, the wind energy is converted into kinetic energy of the shaft 20, and the kinetic energy rotates the magnet 21 fixed to the shaft 20, so that the magnet 21 acts the generator coil 51 which is fixed and stopped inside the generator frame 12 so as to generate electric energy due to changes of magnetic flux. The generated electricity prevents lightning by generating an alternating current. The AC electricity is stabilized through a converter 53, and then, gathered into the power line 52. The gathered electricity may be electricity of a megawatt level or a gigawatt level and more because there are lots of generators.

In this instance, because the power generating apparatus can generate power even though wind blows at speed of 1 m/s to 30 m/s, it can be installed at any place.

The curtain-suspension-type power generating apparatus according to the present invention can be used to generate electricity of megawatt level or the gigawatt level and more.

1. A curtain-suspension-type power generating apparatus, which is a wind turbine generator using wind, comprising:
a plurality of generator bodies, each having integrated turbine blades and a generator frame;
upper and lower wires to which the generator bodies are vertically joined, the upper and lower wires being disposed in parallel for connecting steel towers with each other;
steel towers having pillars for supporting the parallel upper and lower wires;
integrated turbine blades joined in the middle of the generator bodies in a straight line, the integrated turbine blades being curved and formed integrally or formed in a split type;
a shaft fixed to the integrated turbine blade, a magnet being joined to the shaft;
a generator frame joined in the middle of the generator body in a straight line, the generator frame having a generator coil fixed therein and a converter mounted therein, the generator frame being vertically joined to the upper wire;
a screen accommodating the generator bodies therein so as to hide the generator bodies by right and left curved iron plates and to pass just wind to generate power;
a plurality of power lines adapted for connecting electricity generated from a generator coil to a coil current line, connected with converters through converter lines and fixed and arranged on the upper wire side by side via line fasteners inside the generator bodies; and
concrete anchors for providing tensile force to the upper and lower wires by pulling fixed wires from the steel tower,
wherein the generator bodies are bearing-coupled with the rotating turbine blades via a lower shaft, the magnet is joined to one side of the shaft, the generator frame has a generator coil fixed therein and a converter mounted therein and is vertically joined to the upper and lower wires via bolts, the steel towers are erected and supported by the parallel upper and lower wires in such a way as to keep tension by the fixed wires and the concrete anchors, and a lightning rod and lightning lines for preventing lightning are mounted above the upper wire.

2. The curtain-suspension-type power generating apparatus according to claim 1, wherein the integrated turbine blade has an integrated form but, if necessary, has a split form which is divided into two in such a way as to be assembled into one, and is made of steel so as to endure flexural strength, has a turbine blade shaft integrally mounted to the turbine blade and having a bearing jaw, is supported by a thrust bearing and a roller bearing, is sealed by a packing and an oil seal, and is assembled to the shaft by an adhesive, the shaft has bolt fixing holes so as to endure tensile force and compression force, and a lower shaft is disposed.

3. The curtain-suspension-type power generating apparatus according to claim 1, further comprising a wire fixing cover fixed with the upper wire, wire fixing holes and bolts, generator coils, coil current lines connected to the converters, and converter lines connected to the converters to flow electricity to the current lines inside the generator frame, and wherein the generator frame is supported by the shaft, the thrust bearing and the roller bearing, is sealed by the packing and the oil seal, and is regulated and fixed by a bracket.

4. The curtain-suspension-type power generating apparatus according to claim 1, wherein support insulators are disposed to the lightning line for preventing lightning.

5. The curtain-suspension-type power generating apparatus according to claim 1, comprising a two-pillar curtain-suspension-type power generator in which the parallel upper and lower wires are connected between two steel towers, and a plurality of the generator bodies are vertically fixed between the upper and lower wires in order to generate power.

6. The curtain-suspension-type power generating apparatus according to claim 1, comprising a three-pillar curtain-suspension-type power generator in which the parallel upper and lower wires are connected among three steel towers, and a plurality of the generator bodies are vertically fixed between the upper and lower wires in order to generate power.

7. The curtain-suspension-type power generating apparatus according to claim 1, comprising a multiple-pillar curtain-suspension-type power generator in which the parallel upper and lower wires are connected among a great number of steel towers, and a plurality of the generator bodies are vertically fixed between the upper and lower wires in order to generate power.
